(19) United States
(12) Patent Application Publication
(10) Pub. No.: US 2019/0180735 A1
(43) Pub. Date: Jun. 13, 2019

(54) AMBIENT SOUND CLASSIFICATION BASED MESSAGE ROUTING FOR LOCAL SECURITY AND REMOTE INTERNET QUERY SYSTEMS

(71) Applicant: Florida Power & Light Company, Juno Beach, FL (US)

(72) Inventor: Patrick G. MCELHANEY, Juno Beach, FL (US)

(21) Appl. No.: 15/841,045

(22) Filed: Dec. 13, 2017

(51) Int. Cl. G10L 15/08; G10L 15/02; G06F 17/30; H04M 1/60

(52) U.S. Cl. CPC G10L 15/08; G10L 15/02; H04M 1/72538; H04M 1/6008; H04R 2420/07; G06F 17/30864

(57) ABSTRACT

Systems and methods to monitor for diverse audio sounds. A sound signal is received. The sound signal is processed to classify sounds represented by the sound signal as a determined sound type that is one sound type within a plurality of sound types. The plurality of sound types comprising at least spoken words and non-voice security event related sounds. A security event notification is sent to a security monitor based on classifying the sounds as non-voice security event related sounds, and an internet based query is sent to an internet query server based on classifying the sounds as spoken words.

### FIELD OF THE DISCLOSURE

The present disclosure generally relates to selecting destination for messages based on ambient conditions, and more particularly to routing messages to particular destinations based upon classification of detected ambient sounds.

### BACKGROUND

Various sounds exist in modern environments that indicate various conditions or situations. For example, homes generally have a number of sensors that detect various conditions such as smoke, carbon monoxide, other conditions, or combinations of these. In some examples, homes have economical, self-contained sensors that are dedicated to detecting a single condition, such as smoke at the sensor. In some examples, economical sensors are often limited to sounding an audible alarm when the condition associated with the sensor is detected. Some installations include sensors that are connected to a monitoring system that, in turn, is able to provide notifications to external monitoring stations such as a security companies, fire departments, and the like. Installing and maintaining such interconnected sensors and monitoring systems, however, involves additional installation work and related costs.

Some alarm systems include an automated glass breakage audio monitor that is configured to detect the occurrence of the sound of breaking glass. The sound of breaking glass causes an assumption that someone broke a window of the premises being monitored by the alarm system. Detecting the sound of breaking glass, such as with an automated glass breakage detector, is able to cause the condition to be investigated such as by notifying the police or calling the premises. Including such glass breakage sound monitors in alarm systems adds to the complexity and costs of the systems. Further, the range of detection of glass breakage monitors can be limited due to the relatively high audio frequency of the monitored sounds.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 illustrates a residential area interior view 100, according to an example;

FIG. 2 illustrates a residential floor plan 200, according to an example;

FIG. 3 illustrates a diverse ambient sound detector block diagram 300, according to an example;

FIG. 4 illustrates received sound processing flow 400, according to an example;

FIG. 5 illustrates an audio classification and notification dispatch process 500, according to an example; and

FIG. 7 illustrates a block diagram illustrating a processor, according to an example.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the disclosed subject matter in virtually any appropriately detailed structure and function. Further, the terms and phrases used herein are not intended to be limiting, but rather, to provide an understandable description.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The below described systems and methods provide an audio monitoring device that is configured to detect and classify the presence of a number of different types of ambient sounds. In an example, a single device, referred to herein as a diverse ambient sound detector, is configured to detect, process, and classify detected sounds into a number of sound types. In some examples, the sound types include: 1) verbal speech; and 2) certain non-verbal ambient sounds that are related to various events of interest. Examples of events of interest include, but are not limited to, security events such as breaking glass, gunshots, sounding alarms, other security events, or combinations of these.

In some examples, the device responds to the classification of detected ambient sounds as verbal speech by dispatching content that is related to the detected speech to a remote server for appropriate processing. The device responds to the classification of detected ambient sounds as non-verbal ambient sounds related to a particular event of interest by dispatching an indication of an occurrence that event of interest to an appropriate destination. In an example, the device characterizes detected sounds into various sound types, such as a number of sound types that include one or more non-voice security event related sounds.

In an example, a device is able to be configured to listen for a particular verbal sound, such as a key word to wake up, and respond to detecting that particular key word by processing verbal speech spoken after that key word. Such processing is able to include sending indications of the verbal speech to a remote server for processing. In an example, the verbal speech is able to include a question or other command that implies a query to be submitted to the remote server to which the remote server may or may not respond with information. In various examples, the query may consist of a question requesting an answer or other information, a command to perform any operation, any other information to be sent to the remote sever, or any combinations of these. In an example, the server may respond to the query with information. The server is able to respond with information such as audio information to be produced by a speaker of the device. The server is also able to provide various other responses, such as textual, visual, other information, that can be reproduced for or displayed to the person who spoke the verbal speech or command.

In addition to detecting, processing, and sending an indication of detected verbal speech, the device in some examples also listen for and detects non-verbal ambient sounds that are associated with certain events. In an example, in addition to spoken words, the device also detects, for example, non-verbal security event related sounds such as the distinctive sound of glass breaking or an alarm emitted by a smoke or Carbon Monoxide (CO) detector. When ambient sound associated with such an event is detected, which corresponds to such an event occurring, the device in an example sends a signal either: 1) directly to the police; or 2) communicates with a security or smart home system that is able to respond accordingly, such as by contacting appropriate authorities, performing other actions, or combinations of these.

This device that is able to detect and process both verbal speech and non-verbal ambient sounds associated with particular events of interest advantageously allows a single device, such as a device principally focused on only processing spoken words, to also detect the occurrence of events based on detection of ambient sounds associated with those events. In an example, this combination of processing advantageously allows the avoidance of installation time and the expense of alternative approaches to provide for the detection of non-verbal ambient sounds that are related to particular events of interest. For example, such a device is able to advantageously avoid alternatives such as purchasing and installing glass breakage sensors or replacing existing smoke or Carbon Monoxide (CO) detectors that only emit audible alarms to make them compatible and communicate with monitoring systems that are able to contact fire or police.

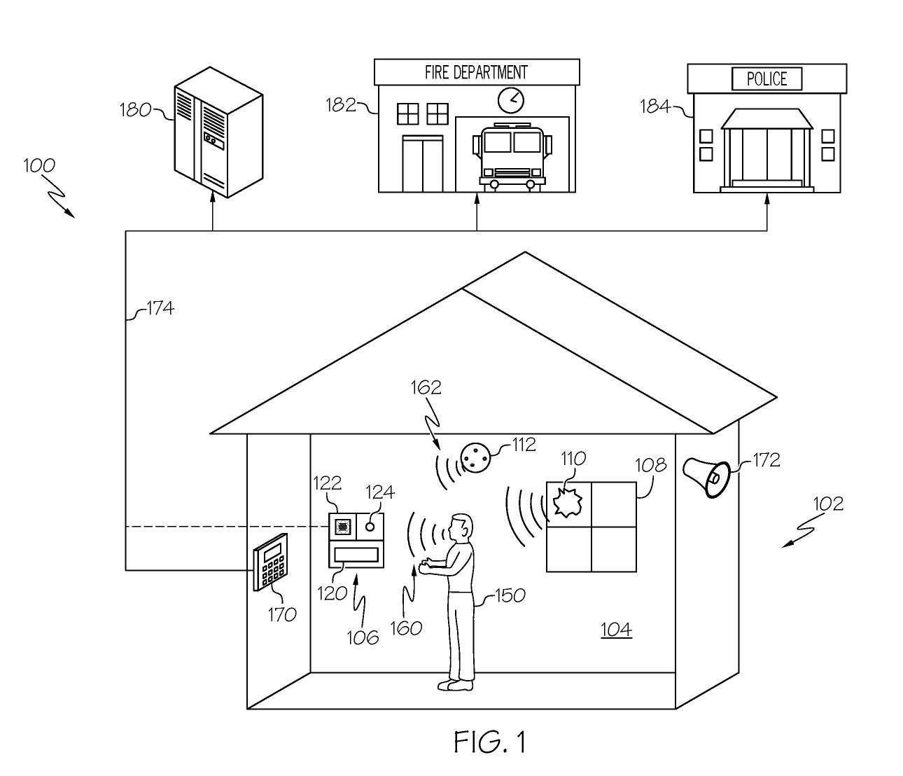

FIG. 1 illustrates a residential area interior view 100, according to an example. The residential area interior view 100 depicts some of the elements in a person's residence 102 that are associated with examples of the operation of an example diverse ambient sound detector 106. The residential area interior view 100 presents a simplified view of the person's residence 102 in order to more clearly present relevant aspects of the below described examples.

The residential area interior view 100 depicts a diverse ambient sound detector 106 located on a wall 104. The diverse ambient sound detector 106 includes a microphone 124 to detect and receive ambient sounds, such as spoken words, other sounds, or combinations of these. The diverse ambient sound detector 106 further has various output devices, such as a speaker 122 and display 120, to present information to persons in the area. The diverse ambient sound detector 106 may be an optional, installable, component of the security system and incorporated at time of initial installation of the security system or retrofitted into the security system after initial installation. The diverse ambient sound detector 106 may be wirelessly coupled to the security system using wireless interface protocols such as WiFi®, Bluetooth®, ZigBee® or other protocols for wirelessly interfacing system components. In general, various diverse ambient sound detectors are able to have any combination of suitable user input/output facilities in addition to one or more microphones to allow information to be exchanged with persons in the area.

The residential area interior view 100 depicts a window 108 in the wall 104. Window 108 is shown to have a broken pane 110. In an example, the broken pane 110 is able to be caused by an intruder or other unauthorized activity that causes at least a part of window 108 to break. The residential area interior view 100 depicts the breaking glass sound waves 160 that are caused by the breaking glass when the broken pane 110 is broken.

The breaking glass sound waves 160 created by breaking at least part of window 108 are received by the microphone 124 of the diverse ambient sound detector 106. Components of the diverse ambient sound detector 106 in an example process the received sounds and classify the breaking glass sound waves 160 as the sound of broken glass. As is described in further detail below, the diverse ambient sound detector 106 is able to respond to received ambient sound being classified as breaking glass by, for example, sending a notification via a communication channel such as the internet to a law enforcement or other monitoring station.

The residential area interior view 100 depicts a smoke detector 112. In an example, the smoke detector 112 is an existing, inexpensive, self-contained, battery operated smoke detector that had been installed into the person's residence 102 prior to installation of the diverse ambient sound detector. The smoke detector 112 in the illustrated example has detected smoke and is emitting smoke alarm sound waves 162. The smoke alarm sound waves 162 created by smoke detector are received by the microphone 124 of the diverse ambient sound detector 106. Components of the diverse ambient sound detector 106 in an example process the received sounds and classify the smoke alarm sound waves 162 as the sound of a smoke alarm indicating detected smoke. As is described in further detail below, the diverse ambient sound detector 106 is able to respond to received ambient sound being classified as a smoke alarm by, for example, sending a notification via a communication channel such as the internet to a fire department or other monitoring station. In such an example the sound may be associated with a smoke alarm based upon its frequency and/or the amplitude envelope of the frequency, ergo the frequency and/or cadence of a “beep” “beep” sound 162 associated with smoke detector 112.

The residential area interior view 100 depicts a person 150 speaking and emitting spoken sound waves 152. The spoken sound waves 152 are also received by the microphone 124 of the diverse ambient sound detector 106. Components of the diverse ambient sound detector 106 in an example process the received sounds and classify the spoken sound waves 152 as human speech. As is described in further detail below, the diverse ambient sound detector 106 is able to respond to received ambient sound being classified as human speech by, for example, sending representations of the spoken sound waves 152 to a server via a communication channel such as the internet.

In an example, an area consisting of a room or adjoining rooms that contains a diverse ambient sound detector 106, or at least a microphone detecting ambient sounds to be received and processed by a diverse ambient sound detector 106, is referred to herein as an area proximate to a sound detector receiving the sounds. In general, the area proximate to the diverse ambient sound detector 106 is an area in which a person normally speaks in order to be heard by the diverse ambient sound detector 106 or an area in which alarms or other sounds can originate and are expected to be reliably detected. In some examples, the diverse ambient sound detector 106, or a microphone detecting sounds to be provided to a diverse ambient sound detector 106, is able to detect loud sounds that originate outside of the area proximate to the sound detector. Such sounds are able to be processed and classified in an example based on their audible characteristics, such as echo content and/or other characteristics.

The residential area interior view 100 further depicts a local security system 170. The local security system 170 is an example of a monitoring system that operates within a premises, where that premises is the person's residence 102. The local security system 170 in some examples is able to include a home security monitoring system that, for example, monitors various sensors around a home, allows securing a home by allowing a user to specify that the home is empty and that door monitors should sound an alarm unless an entry code is entered within a specified time duration. An example of a local security system 170 is the MyPlace™ home security system offered by FPL Smart Services LLC. In some examples, the local security system 170 is able to exchange event detections with the diverse ambient sound detector 106. For example, a diverse ambient sound detector 106 is able to provide an indication of detecting glass breakage to the local security system 170 in order to enhance the operation of the local security system 170.

In an example, the local security system 170 is able to sound an outdoor alarm speaker 172. The outdoor alarm speaker 172 exterior to the premises in which the security system operates and in an example is able to be used to provide local alerts regarding detected glass breakage, smoke, other events within the residence 102 in response to an alert signal generated by the local security system 170.

The residential area interior view 100 further depicts a communications link 174 that allows the diverse ambient sound detector 106, and the local security system 170, to communicate with remote facilities. Although the communications link 174 is shown as a line, in various examples the communications link 174 is able to include one or more of any suitable type of communications, such as one or more of wired communications, wireless communications, other communications techniques, or combinations of these.

The communications link 174 supports communications between the diverse ambient sound detector 106 and various destinations that are selected based on routings specified for particular detected ambient sounds. The residential area interior view 100 depicts a remote server system 180, which receives internet based queries as are described in further detail below. Server system 180 may be one server, a plurality of servers, or any number of servers operating independently of each other, in cooperation with each other, or combinations of these. Various hosting providers are able to provide services that host one or more components of the server system 180. For example, all or part of the processing performed by server system 180 is able to be provided via hosting providers including, but not limited to, Amazon, Google Yahoo, various other providers, or combinations of these. In one example a user may enter a first input allowing selection of and selectively routing to one of a plurality of server systems for receiving processing an internet based query.

In an example, the remote server system 180 is also able to include a number of servers that are each able to receive, process, and respond to internet based queries. In an example, the diverse ambient sound detector 106 supports user programming that specifies a particular server within the number of remote sever systems 180 that is to receive internet based queries. In an example, a user is able to provide a first user input to specify a selected remote server that is to receive internet based queries that originate from detected voice queries. Based on the first input, a user programmable router associated with the diverse ambient sound detector 106 routes internet based queries to the selected remote server system that is specified by the first user input.

In some examples, the diverse ambient sound detector 106 also supports user programming that specifies a particular security service within a number of security services that is to receive alert signals that originate from the local security system 170. In an example, a user is able to provide a second user input to specify a selected security service that is to receive alert signals that originate from the local security system 170. Based on the second input, the user programmable router associated with the diverse ambient sound detector 106 routes alert signals to the selected security service that is specified by the second user input.

Also depicted are other remote systems including security services such as a fire department 182, which receives notifications of smoke alarm soundings, and a police department 184, which receives notifications of glass breakage or other security events, as are described in further detail below. These received notifications in various examples are able to be sent based on the detection of one or more corresponding events. In some example, these notifications are sent by the diverse ambient sound detector 106 when a sound corresponding to one of those events is detected. In some examples, these notifications are the result of alert signals generated by the local security system 170. In some examples, notifications are able to be sent by the diverse ambient sound detector 106, the security system, other systems, or combinations of these. In other examples there may be a plurality of fire or police services available, such as private police or fire services, and the notification may be selectively routed to the service based upon a second user input received by the security system.

In some examples, notifications of events corresponding to detected sounds are able to be sent to a user device. For example, notifications of various events that correspond to detected sounds, such as glass breakage or smoke alarms, are able to be sent to a user device such as a cellular telephone, computer, other device or combinations of these. Such notifications may be sent by e-mail, digital messaging systems such as text messages, by other techniques, or by any combination of these.

In some examples, some sounds are able to be classified as non-voice, non-security events. For example, the diverse ambient sound detector 106 is able to detect sounds such as a washing machine completion tone and classify that type of sound as a non-voice, non-security event. In some examples, non-security event notifications are able to be sent to a user device based on classifying sounds as non-voice, non-security event related sounds. In some examples, the diverse ambient sound detector allows a user to configure one or more various destinations for each of one or more notifications that are sent based on detection or classification of a received sound as a particular sound type.

In some examples, the diverse ambient sound detector 106 is coupled to the local security system 170. In an example, the diverse ambient sound detector 106 is able to send notifications, other data, or combinations of these to the local security system. For example, the diverse ambient sound detector 106 in an example is able to send a notification of a non-voice security event to the local security system 170 when the sound of glass breaking or a sounding of a smoke alarm is detected within sounds received by the diverse ambient sound detector 106. In such an example, the local security system 170 is able to provide other notifications according to its operational configuration. Such a coupling of a diverse ambient sound detector 106 with a local security system allows an efficient and cost effective augmentation of the local security system 170 with the sound recognition functions provided by the diverse ambient sound detector 106. In various examples, the diverse ambient sound detector 106 is able to be added to an existing local security system 170 or included with a newly installed local security system. Coupling between the diverse ambient sound detector 106 and the local security system 170 is able to be by any suitable technique, such as via a wired data connection, a wireless data connection, any communicative coupling technique, or combinations of these.

In some examples, a diverse ambient sound detector 106 that is coupled to a monitoring system such as the above described local security system 170 is able to detect audible alert signals that are generated by various safety sensors. Based on detecting or classifying a received sound as an audible alert signal that is generated by a safety sensor, the diverse ambient sound detector 106 sends a security event notification to the local security system 170. In various examples, a safety sensor is any device that detects a condition and provides an audible alert signal when that condition is detected. Examples of safety sensors include, but are not limited to, the smoke detector 112, a Carbon Monoxide (CO) detector, any other detector, or combinations of these. The diverse ambient sound detector 106 in some examples provides an indication of the type of safety device that is associated with generation of the detected audible alert signal. For example, the diverse ambient sound detector 106 may notify the local security system 170 that a smoke detector has sounded. The local security system 170 in an example is then able to act on these received notifications according to its configuration.

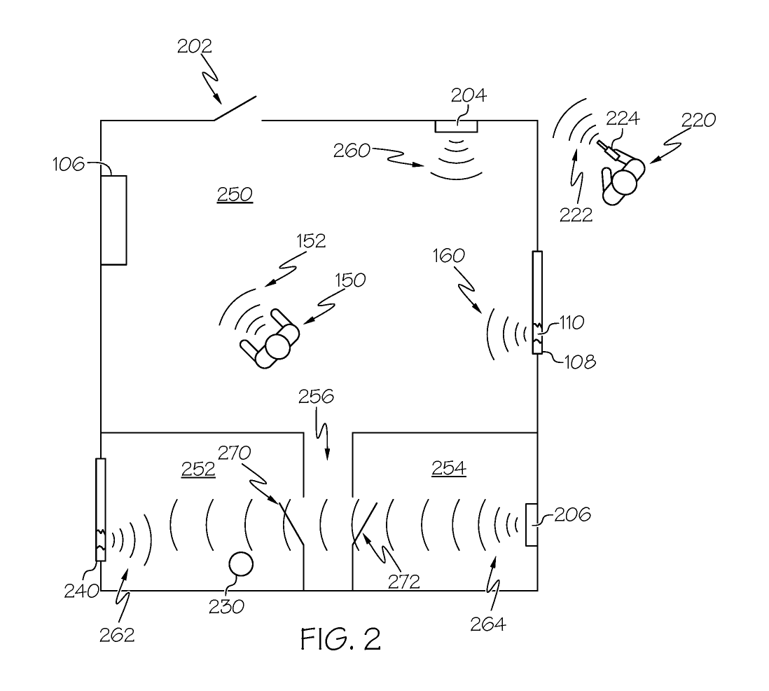

FIG. 2 illustrates a residential floor plan 200, according to an example. The residential floor plan 200 is an example of a residence into which a number of diverse ambient sound detectors have been installed. The residential floor plan 200 includes a living room 250, a first bedroom 252, a second bedroom 254, and a hallway 256.

The living room 250 has an exterior door 202 to enter the residence, a living room window 108, a first diverse ambient sound detector 106, and a first smoke detector 204. The first diverse ambient sound detector 106 is similar to the above described diverse ambient sound detector 106. In this example, the living room 250 is considered as an area that is proximate to the first diverse ambient sound detector 106.

The first smoke detector 204 in the living room 250 in this example has detected smoke and is emitting smoke alarm sound waves 260. As is discussed above, the smoke alarm sound waves 260 are able to be detected by a microphone within the first diverse ambient sound detector 106. Similar to the scenario described above, the living room window 108 also has a broken pane 110 that emits breaking glass sound waves 160 that are detected by the first diverse ambient sound detector 106.

Additionally, a person 150 speaks spoken words and emits spoken sound waves 152 that are also detected by the first diverse ambient sound detector 106.

Additionally a shooter 220 with a gun 224 is outside of the residence and shoots the gun 224, causing gunshot sound waves 222 to be emitted. In this example, the shooter 220 is outside of the area that is proximate to the first diverse ambient sound detector 106. In this example, the first diverse ambient sound detector 106 is able to receive, detect, and process the gunshot sound waves 222 and classify that sound as a distant gunshot because it is outside of the living room 250, and thus outside of the area proximate to the first diverse ambient sound detector 106. The sound of the distant gunshot, which occurs outside the living room 250 is an example of a distant non-voice security event related sound. The first diverse ambient sound detector 106 in an example responds to classifying a received sound as a distant gunshot by sending a notification of a distant security event via a communications channel, such as the internet, to a proper location such as a law enforcement agency or other security monitoring service.

The hallway 256 provides access to and separates the first bedroom 252 and the second bedroom 254. The first bedroom 252 has a first door 270 that opens to the hallway 256, and the second bedroom 254 has a second door 272 that is opposite the first door 270 and also opens to the hallway 256. The first bedroom 252 has a second window 240 and a second diverse ambient sound detector 230. The second bedroom 254 is shown to have a second smoke detector 206.

Because of walls dividing the living room 250 from the first bedroom 252 and the second bedroom 254, and due to other acoustic impediments, the second diverse ambient sound detector 230 located in the first bedroom 252 may be better positioned to receive and more clearly detect and process sounds that originate in the first bedroom 252 and also the second bedroom 254. In this example, the first bedroom 252, the second bedroom 254 and the hallway 256 are considered as the area proximate to the sound detector of the second diverse ambient sound detector 230.

The residential floor plan 200 depicts a second window 240 in the first bedroom 252. A pane breaking in the second window 240 creates a bedroom window glass breakage sound wave 262. The bedroom window glass breakage sound wave 262 propagates to and is received, detected and processed by the second diverse ambient sound detector 230. Due to walls and other acoustic impediments, the bedroom window glass breakage sound wave 262 is not able to propagate to the first diverse ambient sound detector 106.

The second bedroom 254 has a second smoke detector that emits second smoke alarm sound waves 264. The second smoke alarm sound waves 264 in this example are able to propagate to the second diverse ambient sound detector 230 through the second door 272 and the first door 270. In this example, the second smoke alarm sound waves 264 are too attenuated to be adequately received and processed by the first diverse ambient sound detector 106. As is reflected by the ability of the second diverse ambient sound detector 230 to detect the bedroom window glass breakage sound waves 262 and the second smoke alarm sound waves 264 that would not be able to be detected by the first diverse ambient sound detector 106, the ability to locate several diverse ambient sound detectors around a residence provides extended coverage and more reliable detection of sounds associated with events of interest.

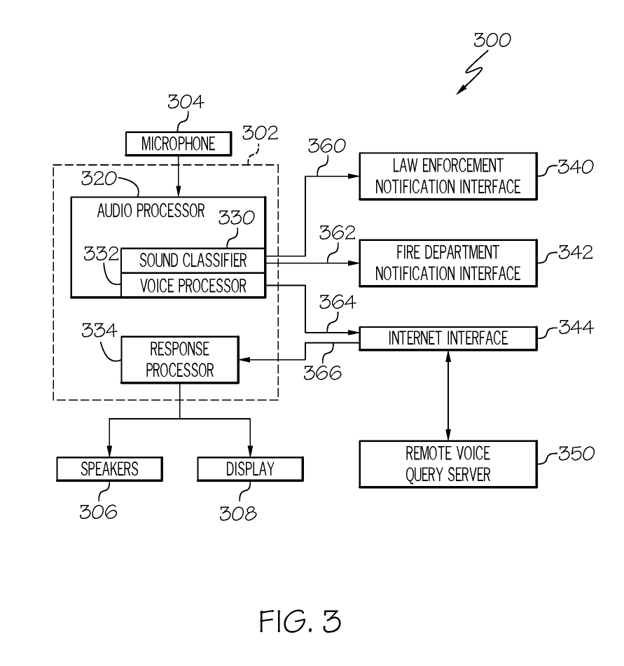

FIG. 3 illustrates a diverse ambient sound detector block diagram 300, according to an example. The diverse ambient sound detector block diagram 300 depicts components internal to and associated with the operation of a diverse ambient sound detector, such as the diverse ambient sound detector 106 described above.

The diverse ambient sound detector block diagram 300 includes a processor 302. In various examples, as is described below, the processor 302 in various examples is able to include any suitable type or combination of types of processing components to perform the operations described herein. In an example, the processor 302 is able to include one or more digital processing devices, analog processing or conditioning devices, various logic components, any other type of processing components, or any combination of these.

The processor 302 in this example receives electronic representations of audio input from a microphone 304. The microphone 304 detects ambient sounds by any suitable means and produces a sound signal that represents the detected ambient sounds. The microphone 304 is an example of a sound receiver that produces a sound signal. These electronic representations of detected sounds are conditioned and processed, such as conversion from analog to digital formats, filtering, other processing, or combinations of these. The conditioned and processed received sound signals that contain representations of sounds detected by the microphone 304 are provided to an audio processor 320 for sound classification and further processing.

The audio processor 320 includes a sound classifier 330 that operates to classify received sound representations according to various criteria. For example, the sound classifier is able to classify received sound signals as being associated with human spoken words, the sound of glass breaking, the sound of a smoke alarm, the sound of a Carbon Monoxide (CO) alarm, the sound of any type of audible alarm or alert signal, a gunshot, sounds associated with other events of interests, or any combination of these. In an example, the sound classifier 330 processes the received sound signal to classify sounds represented by the sound signal as a determined sound type that is one sound type within a number of sound types where the number of sound types includes at least spoken words and non-voice security event related sounds. In a further example, the sound classifier 330 is also able to classify sounds represented by the sound signal as distant non-voice security event related sounds that are sounds associated with security events and that originate outside of an area proximate to a sound detector receiving the sounds and producing the sounds signal.

The sound classifier 330 in some examples is able to perform further actions based upon its classification of particular received sounds. For example, the sound classifier 330 is able to send a security event notification to a security monitor, such as by sending a physical threat notification 360 to law enforcement agencies through a law enforcement notification interface 340 based on classification of received sounds as being associated with security events, such as glass breaking, gunshots, other sounds, or combination of these.

In another example, the sound classifier 330 also is able to send a security event notification to a security monitor by sending a fire notification 362 to fire departments through a fire department notification interface 342 based on classification of received sounds as being associated with alarms indicating the presences of a fire, such as sounds from a smoke alarm or other source. In an example, the sound classifier classifies sounds represented by the sound signal that are sounds received in an area, and the sounds received within the area include a sounding alarm. In such an example, classifying the sounds as security event related sounds includes processing the sound signal to determine that the sound signal represents a sound of the sounding alarm.

In further examples, classification of received audio as being associated with other events is able to cause the sound classifier to send a notification to appropriate one or more destinations. In various examples the notifications are able to be sent to destinations that are internal, external, or to a combination of destinations that are internal and/or external to a facility in which the diverse ambient sound detector is located.

In an example, the law enforcement notification interface 340 is implemented as a communications path to a law enforcement agency and the fire department notification interface 342 is implemented as a communications path to a fire department. In an example, these various communications paths are able to include any type of data transmission over any suitable communications path. In an example, such communications paths include sending data messages over the public Internet to addresses associated with the respective destinations.

The sound classifier 330 is further able to classify received sounds as spoken words. In an example, sounds that are spoken words are represented by the sound signal. The sound classifier 330 classifies the sounds as spoken words by processing the sound signal to determine that the sounds include a speaking voice speaking spoken words. In one example, an internet based query is sent to an internet query server, such as a remote voice query server 350, based upon classifying the sounds as spoken words.

Based on classifying received sounds as spoken words, the sound classifier 330 in an example is able to cause the voice processor 332 to process the representation of sounds received from the microphone 304. In an example, the voice processor 332 processes the same received sounds that were processed by the sound classifier 330 to classify the received sounds. In other words, once the sound classifier classifies a sequence of received sounds as spoken words, that same sequence of received sounds is processed by the voice processor 332.

In various examples, the voice processor 332 is able to perform any type of processing or conditioning of received sound signals that are classified as voice or spoken words. In one example, the voice processor is able to condition the received sounds to send digitized representations of the received sounds to a remote server. In another example, the voice processor 332 is able to perform speech recognition processing on the received sounds to extract data expressed in the spoken words contained in the sounds in order to more efficiently send the spoken words to a remote server.

The voice processor 332 in an example sends spoken words data 364, which is able to include either digitized representations of the sounds or data extracted via speech recognition from the sounds, to a remote voice query server 350. In the illustrated example, the data representing the spoken sounds is transmitted via an internet interface 344. In various examples, any type of internet interface is able to be used, such as wired, wireless, optical, interfaces using other communications modes, or any combination of these. In further examples, the voice processor 332 is able to communicate with a remote voice query server 350 via any suitable technique. Such further examples are able to include any combination of communications modes including one or more of digital, analog, other modes, or combinations of these.

In the illustrated example, the processor 302 also includes a response processor 334 that receives responses 366 from the remote voice query server 350 via the internet interface 344. In an example, the received responses 366 are sent by the remote voice query server 350 based on sending the internet based query to the voice query server. The received responses are able to encode any type of information. In some examples, the received responses 366 include information that can be presented to a user. For example, the received responses 366 are able to include encoded audio signals that the response processor 334 reproduces through speaker 306. In further examples, the received responses 366 includes one or more types of visual data, such as but not limited to text, images, videos, any visual data, or combinations of these, that the response processor reproduces on a display 308. The received responses 366 are able to contain any type of information and may or may not be directly related to the audio data sent to the remote voice query server 350.

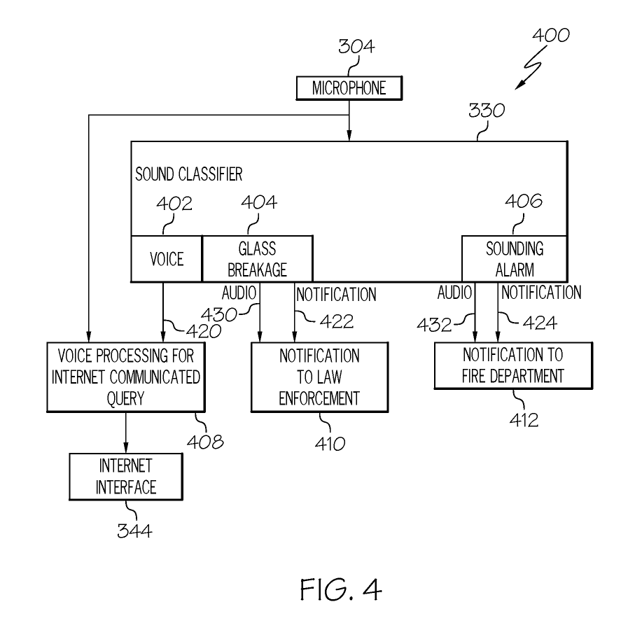

FIG. 4 illustrates received sound processing flow 400, according to an example. The received sound processing flow 400 depicts processing and data flow performed by an example of a processor 302 described above with regards to the diverse ambient sound detector block diagram 300. The description of the received sound processing flow 400 refers to components and descriptions discussed above with regards to the diverse ambient sound detector block diagram 300.

The received sound processing flow 400 depicts the sound classifier 330 receiving representations of received audio signals from microphone 304. The sound classifier 330 performs sound recognition and classification processing on those received audio signals. In order to more clearly and concisely describe the relevant aspects of the present example, the sound classifier 330 is shown to classify the received audio as one of voice, glass breakage, or a sounding alarm. It is clear that further types of classifications can also be performed by the sound classifier 330, such as, without limitation, classifying sound as a gunshot, Carbon Monoxide (CO) alarm, any sound associated with any other event of interest, or combinations of these.

The sound classifier 330 in an example performs processing on signals indicating received sounds to classify the sounds into different classes of sounds, such as classes of voice, glass breakage, or a sounding alarm. The processing of the sound classifier 330 in an example classifies received sounds based on the most likely class to which the received sounds belong. In some examples, the sound classifier assigns likelihoods that a particular received sound belongs to each class and the class with the highest likelihood is the classification produced by the sound classifier 330. Due to the distinctive characteristics of the classes described in this example, i.e., the audio characteristics of glass breaking, sounding alarms, and voice are quite different from one another, the classifications performed by the sound classifier 330 may have a high degree of reliability. In some examples, a sound classifier 330 is able to operate with a lesser degree of reliability in distinguishing between the classes of sounds to which received sounds are to be associated.

The sound classifier 330 has a voice classifier process 402 that indicates the received sounds are likely to be spoken voice. The sound classifier 330 further has a glass breakage classifier process 404 that indicates the received sound is likely broken glass and a sounding alarm classifier process 406 that indicates the received sound is likely a sounding smoke alarm.

The voice classifier process 402 in an example sends a voice indication 420 to a voice processing for internet communicated query component 408. The voice processing for internet communicated query component 408 is an example of the above described voice processor 332. The voice processing for internet communicated query component 408 in an example processes the received sounds according to a suitable technique for transmission over an internet interface 344, such as to a remote voice query server 350 as is described above.

The glass breakage classifier process 404 in an example sends a glass breakage indication 422 to create and send a notification to law enforcement 410. In some examples, a glass breakage audio representation 430 of the audio classified as glass breakage is include in the notification to law enforcement 410. In an example, the notification to law enforcement is a digital message communicated to a law enforcement agency by any suitable technique. In an example, the glass breakage audio representation 430 is included in the notification to law enforcement to allow a person to hear the received sound and make a better judgement regarding the seriousness of the event that caused the sound. For example, a person is able to listen to the glass breakage audio and decide whether it is more likely to have been a window or a drinking glass that caused the sound.

The sounding alarm classifier process 406 in an example sends an alarm indication 424 to create and send a notification to law enforcement 410. In some examples, an alarm audio representation 432 of the audio classified as glass breakage is include in the notification to fire department 412. In an example, the notification to fire department is a digital message communicated to a fire department monitoring facility by any suitable technique. In an example, the alarm audio representation 432 is included in the notification to fire department to allow a person to hear the received sound and make a better judgement regarding the seriousness of the detected alarm. For example, a person is able to listen to the alarm audio and decide whether it is more likely to have been an actual smoke alarm or a similar sound that is not associated with a detection of smoke or fire.

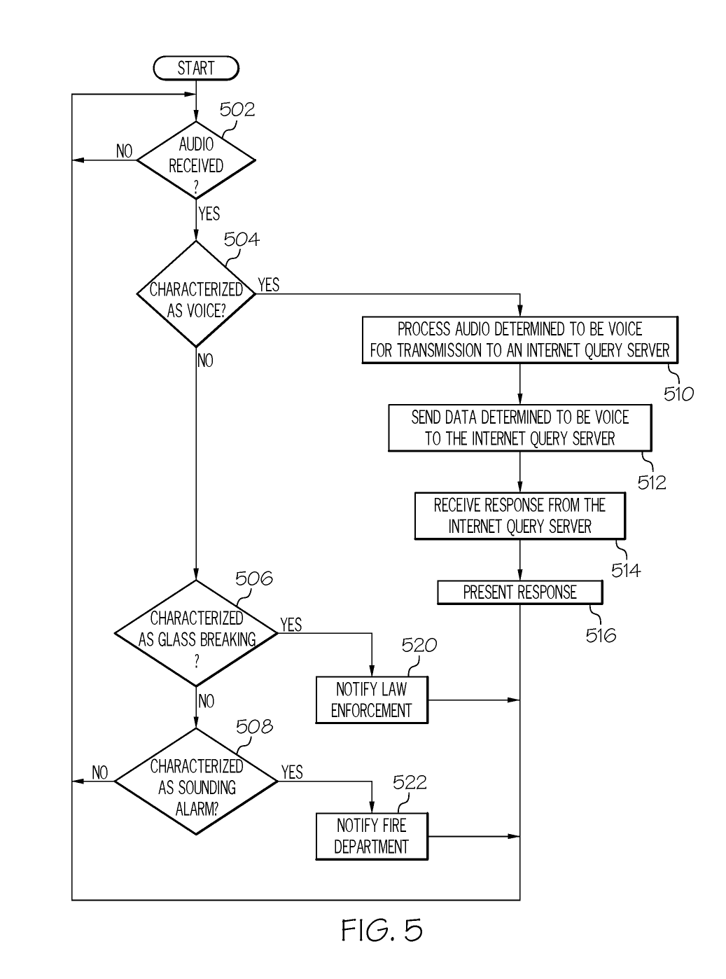

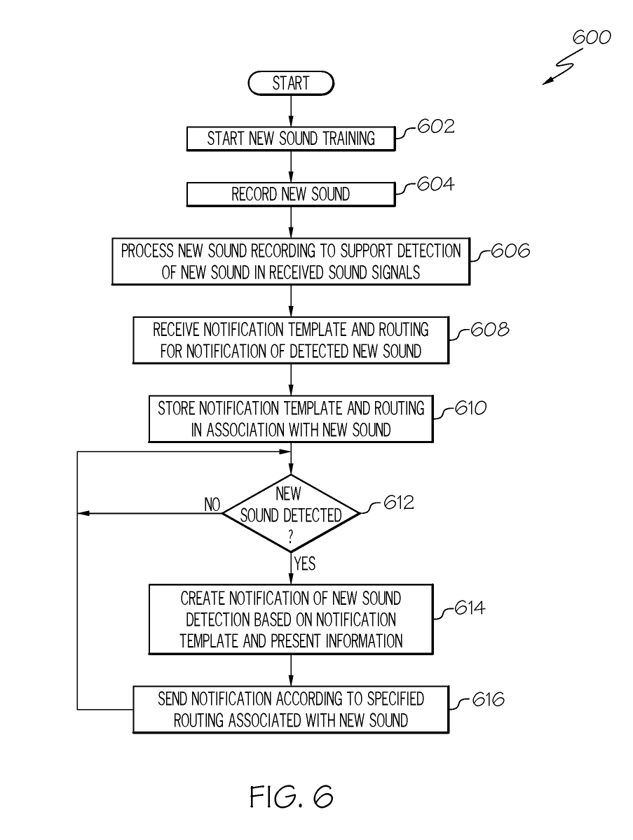

FIG. 5 illustrates an audio classification and notification dispatch process 500, according to an example. The audio classification and notification dispatch process 500 is an example of a process performed by a diverse ambient sound detector 106 as is described above.

The audio classification and notification dispatch process 500 determines, at 502, if audio is received. This determination is able to be based on, for example, an ambient sound level exceeding a threshold. This determination continues until audio is determined to have been received.

The audio classification and notification dispatch process 500 includes determining, at 504, if the received audio is classified as a human voice. Determining that audio contains human voice is able to be performed in various examples by any suitable technique.

If the received audio is determined to be classified as human voice, the audio classification and notification dispatch process 500 in one example processes the audio determined to be human voice for transmission to an internet query server, at 510. The above described remote voice query server 350 is an example of such an internet query server. In various examples, such processing is able to include converting the voice into text data for the internet query. In such an example, speech recognition is applied to the received audio. In further examples, this processing prepares a representation of the received audio itself for sending to the remote voice query server 350, where the remote server performs speech recognition and processing to extract the content of the spoken word contained in the audio. In such examples, the audio classification and notification dispatch process 500 may include conditioning or other processing the speech for transmission to the remote voice query server 350.

In an example, after converting the audio to speech, data determined to be voice is sent, at 512, to the internet query sever. A response from the internet query server is received, at 514. In an example, the received response is based on the data sent to the internet query server. The received response is presented, at 516. Presentation of the received response in various examples is able to include, but is not limited to, reproducing audio received from the internet query server, presenting visual data such as, for example, text, images, videos, other visual data, presentation of any other information, or any combination of presenting any of these types of information. Processing then returns to determining, at 502, if audio is received.

If the received audio is determined to not be characterized as voice, at 504, a determination is made, at 506, as to whether the received audio is characterized as glass breaking. If the received audio is determined to be glass breaking, law enforcement is notified, at 520. Examples of law enforcement notifications are described above. Processing then returns to determining, at 502, if audio is received.

If the received audio is determined to not be characterized as glass breaking, at 506, a determination is made, at 508, as to whether the received audio is characterized as a sounding alarm. If the received audio is determined to be a sounding alarm, a fire department is notified, at 522. Examples of fire department notifications are described above. Processing then returns to determining, at 502, if audio is received.

FIG. 6 illustrates a new sound training and routing programming process 600, according to an example. The new sound training and routing programming process 600 in an example is performed by a diverse ambient sound detector 106. In an example, a diverse ambient sound detector 106 is able to provide user interface elements to facilitate user control and data entry to support the new sound training and routing programming process 600. In further examples, the new sound training and routing programming process 600 is able to be performed on another device, such as a general purpose computer, a remote server, other device, or combinations of these.

In an example, the new sound training and routing programming process 600 allows a user to record a new sound, such as a particular alarm or other sound that indicates an event of interest, program a notification to be provided when that new sound is detected in the future, and allows the user to specify a routing for that notification. For example, a user is able to configure a notification to be provided upon detection of a sounding of a fire alarm. The user is able to train and program a notification in this example by causing the fire alarm to sound and configuring the device to record and “learn” that sound. The user in an example is then able to configure a notification template for the notification and set a routing of that notification to a desired destination, such as a preferred local fire department. Additional example of user configured notifications based on new sound training and programming include programming the device to detect a non-voice non-security event such as a washing machine finished alarm and configuring routing of an associated notification to send the notification to a maid as a task message. Other examples include configuring the device to detect a neighbor's dog bark sound and routing a notification that contains a sound file of the barking to the neighbor's email, configuring the device to detect a baby's crying and routing a notification that contains a baby's photo message to the mother's cell phone.

The new sound training and routing programming process 600 includes starting, at 602, new sound training. In various examples, starting new sound training may include initiating a user interface to allow a user to control aspects of the new sound training and routing programming process 600, providing information regarding the specification of notification templates, provide specifications of routings for notifications associated with the new sound, perform other actions, or combinations of these.

The new sound training and routing programming process 600 continues by recording, at 604, the new sound. Recording the new sound in an example is able to include a user input to start recording the new sound, stopping recording of the new sound at a proper point, replaying the recorded new sound to ensure it was properly captured, re-recording the new sound if desired, perform other options, or combinations of these. Recording the new sound in some examples is performed in conjunction with the user causing the new sound to be made. For example, the user may initiate a test of a fire alarm sound or other sound that is to be detected by the diverse ambient sound detector 106. In other examples, the recording a new sound is initiated when that new sound normally occurs, such as capturing a dog's barking, baby's crying, washing machine finished alarm, other sounds, or combinations of these. In some examples, the new sound is recorded and stored. In further examples, the new sound is processed, as is described in further detail below, as it is received and no recording of the new sound is stored.

The new sound training and routing programming process 600 processes, at 606, the new sound to support detection of the new sound in received audio signals. In an example, this processing extracts features of the new sound to support automated detection of the new sound as ambient sounds are received and processed. In some examples, the processing the new sound to support detection of the new sound is performed on the new sound signal as it is received in the above described recording of the new sound. In further examples, this processing is performed on stored recordings of the new sound.

In an example, processing the new sound to support detection of the new sound is able to be performed with multiple new sounds. In one example, a first new sound signal representing a first new sound is received and the processing the new sound, at 606, in an example includes training a process processing received sound signals to classify the first new sound as a non-voice security event related sound within the plurality of sound types, A second new sound signal representing a second new sound is then received, and the processing the new sound, at 606, in this example includes training the process processing the sound signal to classify the second new sound as the non-voice non-security event related sound within the plurality of sound types

The new sound training and routing programming process 600 receives, at 608, a notification template and routing information for notifications of detection of the new sound. In some examples, notification templates and routing information is provided by a user via a suitable user interface. Notification templates in an example specify the format, content, other characteristics, or combination of these, for notifications that are sent in response to detecting a particular sound. For example, a notification template may specify to send a sound sample along with time, date, location, and other information in response to detecting the sounding of a particular alarm. Routing for a notification specifies in some examples the destination for a particular message. Routings are able to be specified in any suitable manner, such as by e-mail address, destination Universal Resource Locator (URL), other techniques, or combinations of these. In an example, receiving routing information that specifies a notification for a non-voice, non-security event is to be sent to a user device includes receiving a user input indicative of the user device for sending the non-voice non-security event notification to the user device. In the present discussion, routing refers to a specification of a destination of the notification, and does not necessarily specify a path, route, or other communications characteristics, for communications of the notification.

The new sound training and routing programming process 600 stores, at 610, the notification template and routing in association with the new sound. Such storage is able to be accomplished at the diverse ambient sound detector 106 performing the new sound training and routing programming process 600, at a remote system such as a remote server, at any suitable location, or at combinations of these.

After storage of the notification template and routing in association with the new sound, the diverse ambient sound detector 106 is able to operate to detect the presence of the new sound in received sound signals. The new sound training and routing programming process 600 therefore transitions to an operational phase which in an example is part of the normal operation of the diverse ambient sound detector 106. The new sound training and routing programming process 600 determines, at 612, if the new sound is detected. If the new sound is not detected, the new sound training and routing programming process 600 continues to perform this determination until it is true.

Upon determination of a detection of the new sound, at 612, the new sound training and routing programming process 600 creates, at 614, a notification of the new sound detection based on the notification template and present information concerning the detected new sound. Examples of present information include information that is added to the notification template to reflect the current status or environment of the detected sound. For example, a notification template is able to specify that a recording of the detected received sound signal should be included with a notification of the detected sound that is sent to a specified destination. In such a case, the creation of the notification will add the recording to the notification. Further, status information such as time of day, date, location, other information, or combinations of these, are also examples of present information that is inserted into notifications that are sent according to their specified routing.

After creating the notification, the notification is sent, at 616. Sending the notification in various examples includes sending the notification to the destination specified by the routing associated with the particular new sound. In some examples, the notification is sent with a particular medium or protocol based upon the specified routing. For example, a specified routing for a notification may specify that the notification is to be sent as an e-mail. In such an example, the notification is sent according an e-mail protocol to the destination specified by the routing. In another example, the routing may specify the notification is to be sent as a text message. The notification in such an example is sent according to a text messaging protocol to the destination specified by the routing. In some examples, notifications of such trained events are able to be sent to a user device by any suitable technique. In an example, the above described new sound is a non-voice non-security event related sound. In such an example, a non-security event notification is sent to a user device based on a receiving the new sound and its being classified as a non-voice non-security event related sound. being able to be an indication of a non-voice non-security event and detection of such a new sound causes sending a non-security event notification. After sending the notification, the new sound training and routing programming process 600 returns to determining, at 612, if the new sound is detected, and continues with the subsequent processing described above.

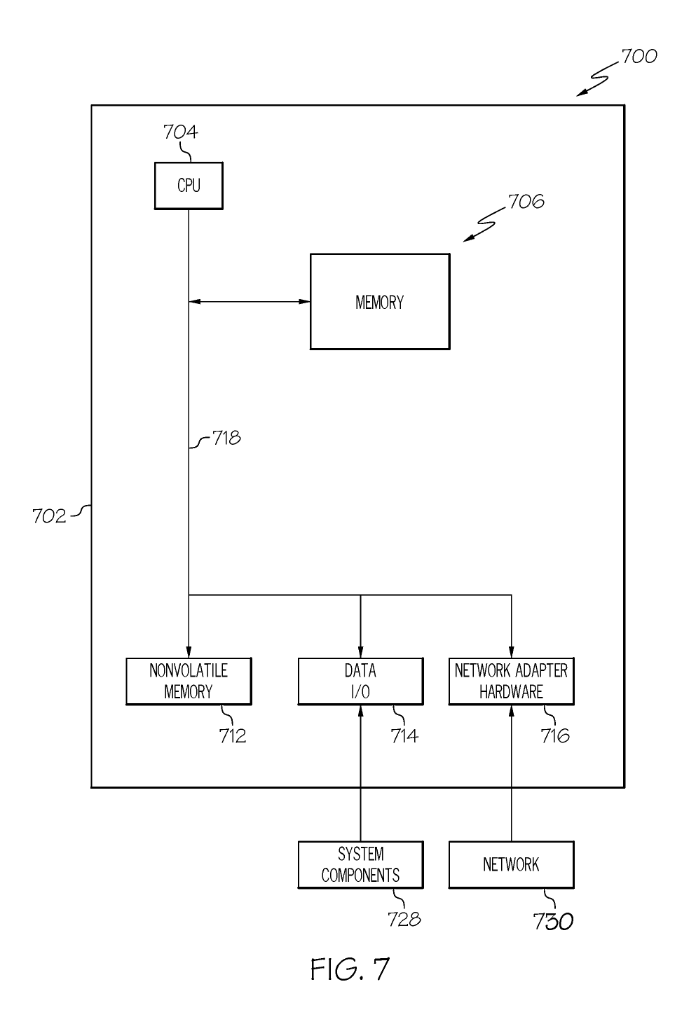

FIG. 7 illustrates a block diagram illustrating a processor 700 according to an example. The processor 700 is an example of a processing subsystem that is able to perform any of the above described processing operations, control operations, other operations, or combinations of these.

The processor 700 in this example includes a CPU 704 that is communicatively connected to a main memory 706 (e.g., volatile memory), a non-volatile memory 712 to support processing operations. The CPU is further communicatively coupled to a network adapter hardware 716 to support input and output communications with external computing systems such as through the illustrated network 730.

The processor 700 further includes a data input/output (I/O) processor 714 that is able to be adapted to communicate with any type of equipment, such as the illustrated system components 728. The data input/output (I/O) processor in various examples is able to be configured to support any type of data communications connections including present day analog and/or digital techniques or via a future communications mechanism. A system bus 718 interconnects these system components.

Information Processing System

The present subject matter can be realized in hardware, software, or a combination of hardware and software. A system can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein.

The present subject matter can also be embedded in a computer program product, which comprises all the features enabling the implementation of the methods described herein, and which—when loaded in a computer system—is able to carry out these methods. Computer program in the present context means any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory, CD-ROM, and other permanent storage. Additionally, a computer medium may include volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information. In general, the computer readable medium embodies a computer program product as a computer readable storage medium that embodies computer readable program code with instructions to control a machine to perform the above described methods and realize the above described systems.

Non-Limiting Examples

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

What is claimed is:

1. A method comprising:
receiving a sound signal;
processing the sound signal to classify sounds represented by the sound signal as a determined sound type that is one sound type within a plurality of sound types, the plurality of sound types comprising at least spoken words and non-voice security event related sounds;
sending a security event notification to a security monitor based on classifying the sounds as non-voice security event related sounds; and
sending an internet based query to an internet query server based on classifying the sounds as spoken words.

2. The method according to claim 1, wherein the sounds represented by the sound signal are sounds received in an area, wherein the sounds received within the area comprise a sounding alarm, and wherein classifying the sounds as security event related sounds comprises processing the sound signal to determine that the sound signal comprises a sound of the sounding alarm within the sound signal.

3. The method according to claim 1, further comprising:
receiving, based on sending the internet based query to the internet query server, a response from the internet query server; and
presenting the response.

4. The method according to claim 1,
wherein the plurality of sound types further comprises distant non-voice security event related sounds, the distant non-voice security event related sounds comprising sounds that are associated with security events and that originate outside of an area proximate to a sound receiver receiving the sounds and producing the sounds signal,
the method further comprising:
sending a distant security event notification to the security monitor based on classifying the sounds as distant non-voice security event related sounds.

5. The method according to claim 1,
wherein the plurality of sound types further comprises an audible alert signal generated by a safety sensor,
wherein the sending the security event notification further comprises sending, based on classifying the sounds as the audible alert signal, the security event notification to a monitoring system that monitors a premises.

6. The method according to claim 1, wherein the sounds represented by the sound signal are sounds received in an area, wherein the sounds received within the area comprise spoken words, and wherein classifying the sounds as spoken words comprises processing the sound signal to determine that the sounds comprises a speaking voice, and
wherein the sending the internet based query comprises sending content of the sounds to the internet query server.

7. The method of claim 6, wherein sending content of the sounds comprising sending a digitized representation of the sounds to the internet query server.

8. The method of claim 6, further comprising performing, based on classifying the sounds as spoken words, speech recognition on the sounds to extract data expressed in the spoken words, and
wherein sending content of the sounds comprises sending the data expressed in the spoken words to the internet query server.

9. The method according to claim 1, wherein
the plurality of sound types further comprises a non-voice non-security event related sound, and
the method further comprises sending a non-security event notification to a user device based on classifying the sounds as non-voice non-security event related sounds.

10. The method according to claim 9 further comprising:
receiving, prior to receiving the sound signal, a first new sound signal representing a first new sound;
training a process processing the sound signal to classify the first new sound as the non-voice security event related sound within the plurality of sound types;
receiving, prior to receiving the sound signal, a second new sound signal representing a second new sound;
training the process processing the sound signal to classify the second new sound as the non-voice non-security event related sound within the plurality of sound types; and
receiving a user input indicative of the user device for sending the non-voice non-security event notification to the user device.

11. A diverse ambient sound detector, comprising:
an audio processor that, when operating, receives a sound signal; and
a sound classifier that, when operating:
processes the sound signal to classify sounds represented by the sound signal as a determined sound type that is one sound type within a plurality of sound types, the plurality of sound types comprising at least spoken words and non-voice security event related sounds;
sends a security event notification to a security monitor based on classifying the sounds as non-voice security event related sounds; and
sends an internet based query to an internet query server based on classifying the sounds as spoken words.

12. The diverse ambient sound detector according to claim 11, wherein the sounds represented by the sound signal are sounds received in an area, wherein the sounds received within the area comprise a sounding alarm, and
wherein the sound classifier classifies the sounds as security event related sounds by at least processing the sound signal to determine that the sound signal comprises a sound of the sounding alarm within the sound signal.

13. The diverse ambient sound detector according to claim 11, further comprising:
a response processor that, when operating:
receives, based on sending the internet based query to the internet query server, a response from the internet query server; and
presents the response.

14. The diverse ambient sound detector according to claim 11,
wherein the plurality of sound types further comprises distant non-voice security event related sounds, the distant non-voice security event related sounds comprising sounds that are associated with security events and that originate outside of an area proximate to a sound detector receiving the sounds and producing the sounds signal,
wherein the sound classifier, when operating, further sends a distant security event notification to the security monitor based on classifying the sounds as distant non-voice security event related sounds.

15. The diverse ambient sound detector according to claim 11 wherein the sounds represented by the sound signal are sounds received in an area, wherein the sounds received within the area comprise spoken words, and
wherein the sound classifier:
classifies the sounds as spoken words by at least processing the sound signal to determine that the sounds comprises a speaking voice, and
sends the internet based query by at least sending content of the sounds to the internet query server.

16. The diverse ambient sound detector of claim 15, wherein the sound classifier, when operating:
further performs, based on classifying the sounds as spoken words, speech recognition on the sounds to extract data expressed in the spoken words, and
sends content of the sounds by at least sending the data expressed in the spoken words to the internet query server.

17. A security system comprising:
an installable diverse ambient sound detector coupled to a monitoring system, the installable diverse ambient sound detector comprising:
an audio processor that, when operating, receives a sound signal; and
a sound classifier that, when operating:
processes the sound signal to classify sounds represented by the sound signal as a determined sound type that is one sound type within a plurality of sound types, the plurality of sound types comprising at least spoken words and non-voice security event related sounds;
sends an internet based query to an internet query server based on classifying the sounds as spoken words; and
sends a security event notification to the monitoring system based on classifying the sounds as the non-voice security event related sounds.

18. The security system according to claim 17 further comprising:
the monitoring system, wherein the monitoring system monitors a premises and further comprises an outdoor alarm speaker for generating an audio alert exterior to the premises; and
a safety sensor that generates an audible alert signal, and
where the plurality of sound types further comprises the audible alert signal,
where the sound classifier, when operating, sends the security event notification to the monitoring system based on classifying the sounds as the audible alert signal.

19. The security system according to claim 18 wherein the sound classifier, when operating, further sends the security event notification to a security service comprising at least one of a fire department or a police department.

20. The security system according to claim 19 wherein the sound classifier further comprises a user programmable router that, when operating, is configured to:
receive a first user input identifying the internet query server from within a plurality of internet query servers; and
receive a second user input identifying the security service from within a plurality of security services.
